(19) United States
(12) Patent Application Publication
(10) Pub. No.: US 2015/0215842 A1
(43) Pub. Date: Jul. 30, 2015

(54) REQUESTING RESOURCES FOR DEVICE-TO-DEVICE (D2D) COMMUNICATION

(71) Applicant: Alcatel Lucent, Paris (FR)

(72) Inventors: Seau Sian Lim, Swindon (GB); Sudeep Palat, Swindon (GB); Fang-Chen Cheng, Randolph, NJ (US)

(73) Assignee: Alcatel Lucent, Paris (FR)

(21) Appl. No.: 14/168,653

(22) Filed: Jan. 30, 2014

(51) Int. Cl. H04W 40/16; H04L 12/721; H04L 12/26

(52) U.S. Cl. CPC H04W 40/16; H04L 43/0829; H04L 45/70

(57) ABSTRACT

A device, such as user equipment, to transmit a preamble in a preamble resource to indicate one or more communication resources for a device-to-device (D2D) communication channel and transmit voice or data over the D2D communication channel using the one or more communication resources in response to absence of an indication of a collision in the preamble resource. User equipment may also detect a preamble in a preamble resource that indicates the one or more communication resources for a device-to-device (D2D) communication channel and monitor the one or more communication resources for D2D communication in response to detecting the preamble in the preamble resource.

### BACKGROUND

1. Field of the Disclosure

The present disclosure relates generally to wireless communication and, more particularly, to wireless device-to-device (D2D) communication.

2. Description of the Related Art

Wireless communication systems provide wireless connectivity to user equipment using a network of interconnected access nodes or base stations. Communication over the air interface between the user equipment and the base stations takes place according to various agreed-upon standards and/or protocols. For example, the Third Generation Partnership Project (3GPP, 3GPP2) has specified a set of standards for a packet-switched wireless communication system referred to as Long Term Evolution (LTE). The LTE standards support access schemes including single-carrier frequency division multiple access (SC-FDMA). Multiple users can concurrently access the SC-FDMA network using different sets of non-overlapping Fourier-coefficients or sub-carriers. One distinguishing feature of SC-FDMA is that it leads to a single-component carrier transmit signal. The LTE standards also support multiple-input/multiple-output (MIMO) communication over the air interface using multiple antennas deployed at transmitters and/or receivers. The carrier bandwidth supported by LTE is approximately 20 MHz, which can support a downlink peak data rate of approximately 100 Mbps and a peak data rate of the uplink of approximately 50 Mbps.

User equipment may implement transceivers that include a transmitter for transmitting uplink signals towards the network and a receiver for receiving downlink signals transmitted by the network. Transceivers implemented in user equipment may communicate according to the SC-FDMA standards or protocols using different sets of non-overlapping Fourier-coefficients or sub-carriers. User equipment conventionally communicate with each other by transmitting signals over a communication path that originates at the transmitter of the first user equipment, travels over an uplink (or reverse link) to a receiver in a network base station, proceeds to a transmitter in the receiving base station or another base station, and is then transmitted over a downlink (or forward link) to a receiver in the second user equipment. Consequently, a conventional network communication path between the two user equipment includes network elements such as base stations, switches, and routers. However, future generations of wireless communication protocols are likely to support device-to-device (D2D) communication that does not necessarily include the network in the communication path. For example, D2D communication allows two user equipment to communicate directly with each other over an air interface between the two user equipment. No network elements are included in the D2D communication path. The D2D communication protocols can be used to support voice or data transmission on a one-to-many basis, e.g., for push-to-talk (PTT) or other broadcast applications. The D2D communication protocols may also support high data rate applications such as multimedia services or low data rate applications.

Some D2D communication protocols support a half-duplex link over the air interface so that user equipment can either transmit or receive during a time interval but the user equipment cannot concurrently transmit and receive information. Consequently, conventional techniques for avoiding collisions between transmissions by different user equipment may not be effective in D2D communication. For example, a conventional carrier sense multiple access (CSMA) scheme may avoid collisions by “listening” to the carrier signal used to convey information concurrently with transmitting information using the carrier signal. The user equipment stops transmission if it “hears” a transmission by another user equipment on the carrier signal. This approach may not be effective in half-duplex D2D communication because user equipment cannot concurrently listen and transmit. For another example, user equipment in a conventional CSMA scheme may detect potential collisions by transmitting a request-to-send message and waiting for another device to send a clear-to-send message to indicate that the requested resources have been reserved for the requesting user equipment. This approach may not be effective in one-to-many D2D communication because it is difficult to decide which receiving device has the authority and responsibility for returning the clear-to-send message on behalf of all user equipment.

### SUMMARY OF EMBODIMENTS

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a method is provided for requesting resources for D2D communication. Some embodiments of the method include transmitting a preamble in a preamble resource to indicate one or more communication resources for a device-to-device (D2D) communication channel. Some embodiments of the method also include transmitting voice or data over the D2D communication channel using the one or more communication resources in response to absence of an indication of a collision in the preamble resource.

In another embodiment, a method is provided for receiving D2D communication. Some embodiments of the method include detecting a preamble in a preamble resource that indicates one or more communication resources for a device-to-device (D2D) communication channel. Some embodiments of the method also include monitoring the one or more communication resources for D2D communication in response to detecting the preamble in the preamble resource.

In yet another embodiment, an apparatus is provided for performing D2D communication. Some embodiments of the apparatus include a transmitter to transmit a preamble in a preamble resource to indicate one or more communication resources for a device-to-device (D2D) communication channel and transmit voice or data over the D2D communication channel using the one or more communication resources in response to absence of an indication of a collision in the preamble resource.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a wireless communication system according to some embodiments.

FIG. 2 is a block diagram of a resource grid for one timeslot according to some embodiments.

FIG. 3 is a block diagram of a wireless communication system that supports D2D communication according to some embodiments.

FIG. 4 is a plot of preamble resources that may be used to transmit a preamble to indicate a communication resource distribution according to some embodiments.

FIG. 5 is a plot of preamble resources that may be used to transmit a preamble to indicate a communication resource distribution according to some embodiments.

FIG. 6 is a plot of preamble resources that may be used to transmit one of a plurality of preambles to indicate one of a plurality of communication resource distributions according to some embodiments.

FIG. 7 is a plot of preamble resources that may be used to transmit a preamble to indicate a communication resource distribution according to some embodiments.

FIG. 8 is a plot of preamble resources that may be used to transmit a preamble to indicate one of a plurality of communication resource distributions according to some embodiments.

FIG. 9 is a flow diagram of a method for requesting resources for D2D communication according to some embodiments.

FIG. 10 is a flow diagram of a method for receiving D2D communication using requested communication resources according to some embodiments.

### DETAILED DESCRIPTION

The resources lost due to collisions between D2D transmissions from multiple user equipment can be reduced by implementing a two-step transmission process. In the first step, a user equipment uses a predetermined shared resource to transmit a preamble that indicates resources that are to be subsequently used for a D2D communication channel. In the second step, the user equipment transmits voice or data information over the D2D communication channel using the indicated resources in response to an indication that the preamble did not collide with transmission from another user equipment. The resource used to transmit the preamble is smaller than the resources used for the D2D communication channel. Consequently, fewer resources are lost to contention because user equipment only contend for the resources used to transmit the preamble.

In some embodiments, the preamble can selectively indicate one of a plurality of distributions of resources that may be allocated to the D2D communication channel. For example, one value of the preamble may indicate a first distribution of resources that includes a relatively small number of physical resource blocks and another value of the preamble may indicate a second distribution of resources that includes a relatively large number of physical resource blocks. Different resource distributions for the D2D communication channel may also be indicated by the resource used to transmit the preamble. For example, one distribution may be requested by transmitting the preamble in one of a first set of resources and another distribution may be requested by transmitting the preamble in one of a second set of resources. Some embodiments may allow user equipment to make a standing reservation for resources that is maintained until the user equipment transmits a preamble that indicates that the standing reservation has been terminated.

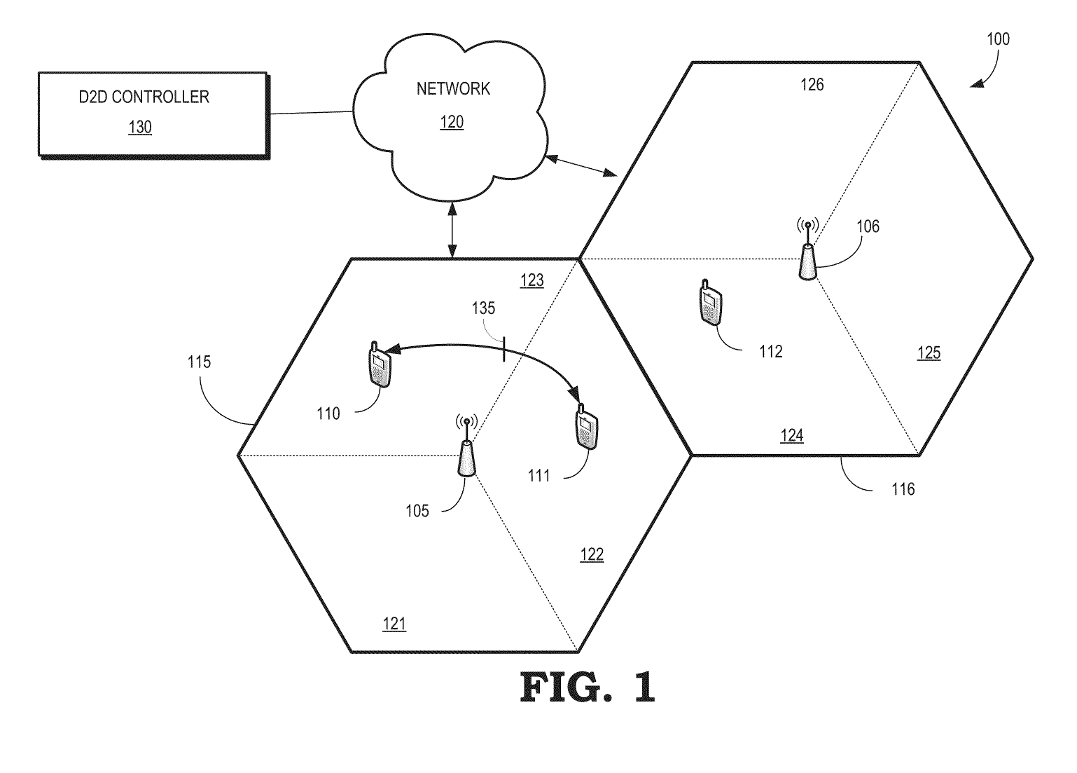

FIG. 1 is a block diagram of a wireless communication system 100 according to some embodiments. The wireless communication system 100 includes base stations 105, 106 that are configured to provide wireless connectivity to user equipment 110, 111, 112 (collectively referred to herein as “user equipment 110-112”) in corresponding cells 115, 116. Some embodiments of the wireless communication system 100 also include a network 120 for facilitating communication between network elements such as the base stations 105, 106 and other elements within the system 100 or elements that are external to the system 100. Communication between the base stations 105, 106 and user equipment 110-112 may be performed according to the Long Term Evolution (LTE) standards or protocols defined by the Third Generation Partnership Project (3GPP, 3GPP2) for packet-switched wireless communication systems. However, some embodiments may use other standards or protocols for supporting communication within the wireless communication system 100.

Each cell 115, 116 is subdivided into sectors 121, 122, 123, 124, 125, 126 (collectively referred to as “the sectors 121-126”) that may be served independently. For example, the base stations 105, 106 may implement or deploy antenna configurations and hardware, firmware, or software that allows the user equipment 110-112 in the different sectors 121-126 to be served independently. User equipment 110-112 may hand off when they transition between different sectors 121-126. Although the cells 115, 116 are depicted in FIG. 1 as perfect hexagons and the sectors 121-126 are depicted as identical parallelograms that perfectly subdivide the cells 115, 116, persons of ordinary skill in the art having benefit of the present disclosure should appreciate that actual cells 115, 116 or sectors 121-126 may have irregular shapes that may vary in time due to geography, topography, environmental conditions, configuration of the base stations 105, 106, changing antenna configurations, or other factors.

The wireless communication system 100 includes one or more D2D controllers 130 that are used to configure or control D2D communication within the wireless communication system 100. As used herein, the term “D2D communication” refers to communication between at least two user equipment 110-112 that does not include network elements such as base stations 105, 106 in the communication path between the user equipment 110-112 that are participating in the D2D communication session. Thus, D2D communication occurs over an air interface established between the different user equipment 110-112 involved in the D2D communication session. For example, the user equipment 110 and the user equipment 111 may communicate using one or more D2D communication channels established over the air interface 135. The D2D communication can occur over an air interface established between two user equipment or over an air interface shared by more than two user equipment. Transmissions over the air interface 135 may be divided into frames or subframes to facilitate synchronization of communication between the base stations 105, 106 and user equipment 110-112.

Although network elements such as the base stations 105, 106 are not in the communication path during D2D communication, the network may still participate in or monitor the communication. For example, the network may provide a network timing that can be used by the user equipment 110-112 as the reference time for deriving the timing of other user equipment during the D2D communication. Furthermore, entities in the network 120 or the D2D controller 130 may monitor D2D communication between two or more user equipment, e.g., so that the network can manage the radio resource and control the users for “leasing” air interface resources for the D2D communication.

The D2D controller 130 is depicted in FIG. 1 as a stand-alone entity that can communicate with the base stations 105, 106 via the network 120. However, some embodiments of the D2D controller 130 may be deployed in different locations or in a distributed fashion at multiple locations in the wireless communication system 100. For example, the D2D controller 130 may be implemented in the base stations 105, 106 or at other locations within the wireless communication system 100.

Some embodiments of the D2D controller 130 authenticate user equipment 110-112 for D2D communication in two different modes: the network-assist mode and the network-absent mode. In the network-assist mode, network side elements such as the base stations 105, 106 or the D2D controller 130 are available and can communicate with user equipment 110-112. The user equipment 110-112 may therefore use a network timing reference for communication with the network as well as D2D communication. The network may also provide D2D authentication, authorization, communication parameters, and the like concurrently with user equipment 110-112 initiating D2D communication in the network-assist mode. In the network-absent mode, the network is not available to provide a network timing reference or other information, such as signaling control and system information, to the user equipment. Thus, user equipment 110-112 that participate in network-absent D2D communication may have been pre-configured or pre-authorized to perform D2D communication without any network assistance or intervention at the time of the D2D communication session.

In one embodiment that implements the network-assist mode, the wireless communication system 100 may authorize user equipment 110-112 for D2D communication in response to a request from the user equipment 110-112 and before the user equipment 110-112 performs device discovery to detect other user equipment 110-112. The requesting user equipment 110-112 may have acquired LTE system information and locked to the downlink timing of its serving cell 115 before the user equipment 110-112 is authorized to perform the D2D device discovery or communication. The requesting user equipment 110-112 may discover other user equipment 110-112 by detecting a sounding reference signal (SRS) and so the user equipment 110-112 may be configured to transmit periodic SRS with a configurable time interval that may be known by other devices in the wireless communication system 100.

In one embodiment that implements the network-absent mode, the wireless communication system 100 may authorize user equipment 110-112 for D2D communication prior to user equipment 110-112 initiating D2D communication so that the user equipment 110-112 is pre-authorized or pre-configured for D2D communication in the event that the network becomes unavailable or absent. The network-absent mode may be particularly useful to support D2D communication in emergency situations, during natural disasters, and other situations where public safety is at risk. Prior to operating in the network-absent mode, user equipment 110-112 may be pre-authorized by the D2D controller 130 for subsequent D2D communication when the network is not available to assist device discovery. User equipment 110-112 may establish the network-absent mode of D2D communication in response to determining that the network is not available or present.

User equipment 110-112 that are authorized to participate in D2D communication may be configured to request or reserve communication resources for establishing communication channels for D2D communication by transmitting a preamble in a preamble resource, such as a physical resource block defined by a time interval and a frequency band, as discussed herein. The preamble, the preamble resource, or a combination thereof may indicate one or more communication resources that are used to establish the D2D communication channel. If the user equipment 110-112 do not detect any indication of a collision in the preamble resource, the user equipment 110-112 assumes that no other device is attempting to use the requested communication resources and may therefore transmit voice or data over the D2D communication channel using the reserved communication resource. Other user equipment 110-112 in the system 100 may detect the preamble in the preamble resource and then monitor the reserved communication resource for D2D communication.

The user equipment 110-112 may store information that is used to map the communication resources to the preamble, the preamble resource, or a combination thereof. The D2D controller 130 may provide a map to the user equipment 110-112 in response to a request to initiate D2D communication (e.g., in the network-assist mode) or the map may be pre-provisioned to the user equipment 110-112 (e.g., so that the user equipment 110-112 can request resources for D2D communication in the network-absent mode). The user equipment 110-112 may then use the stored map to select the preamble, the preamble resource, or a combination thereof that indicates the requested communication resources. The user equipment 110-112 may also use the stored map to decide which communication resources to monitor in response to detecting the preamble in the preamble resource.

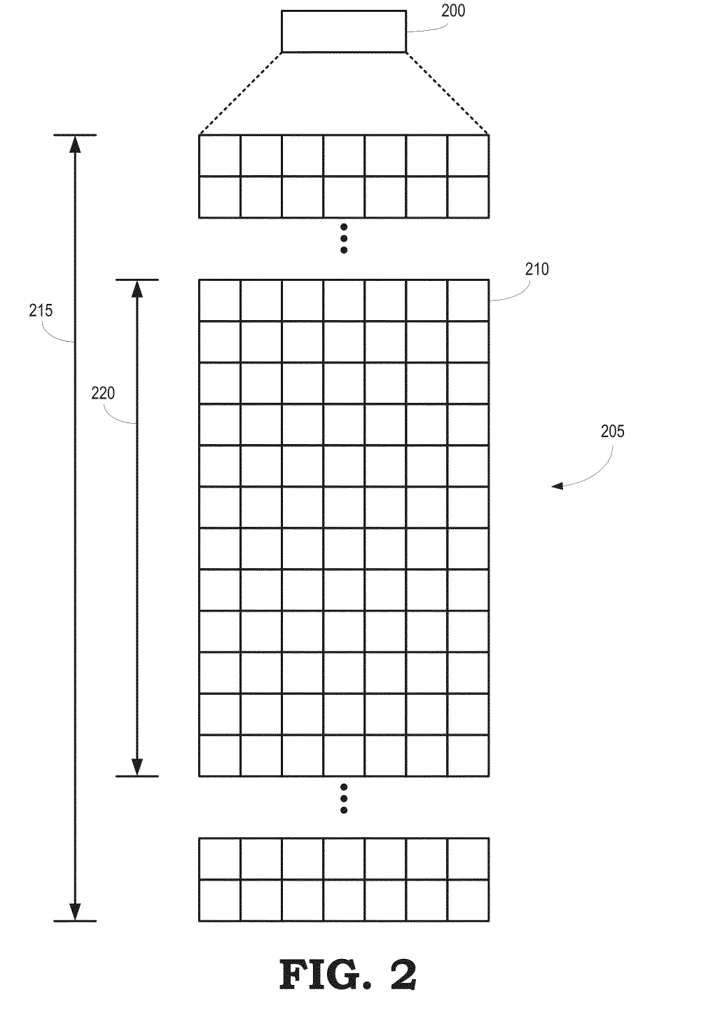

FIG. 2 is a block diagram of a resource grid 200 for one timeslot 205 according to some embodiments. Each subframe used for communication over an air interface such as the air interface 135 shown in FIG. 1 may include one or more timeslots such as the timeslot 205 shown in FIG. 2. The timeslot 205 is divided into a plurality of resource elements or physical resource blocks 210 (only one indicated by a reference numeral in the interest of clarity) that are defined by a time interval and a frequency band or subcarrier frequency. For example, the timeslot 205 may have a total duration of 0.5 ms and may be divided into seven (7) time intervals that are distributed along the horizontal direction in FIG. 2. The timeslot 205 may also include a predetermined number 215 of frequency bands or subcarrier frequencies that are distributed along the vertical direction in FIG. 2. The number 215 may depend upon the transmission bandwidth of the air interface. The predetermined number 215 may also be divided into one or more subsets 220 of physical resource blocks.

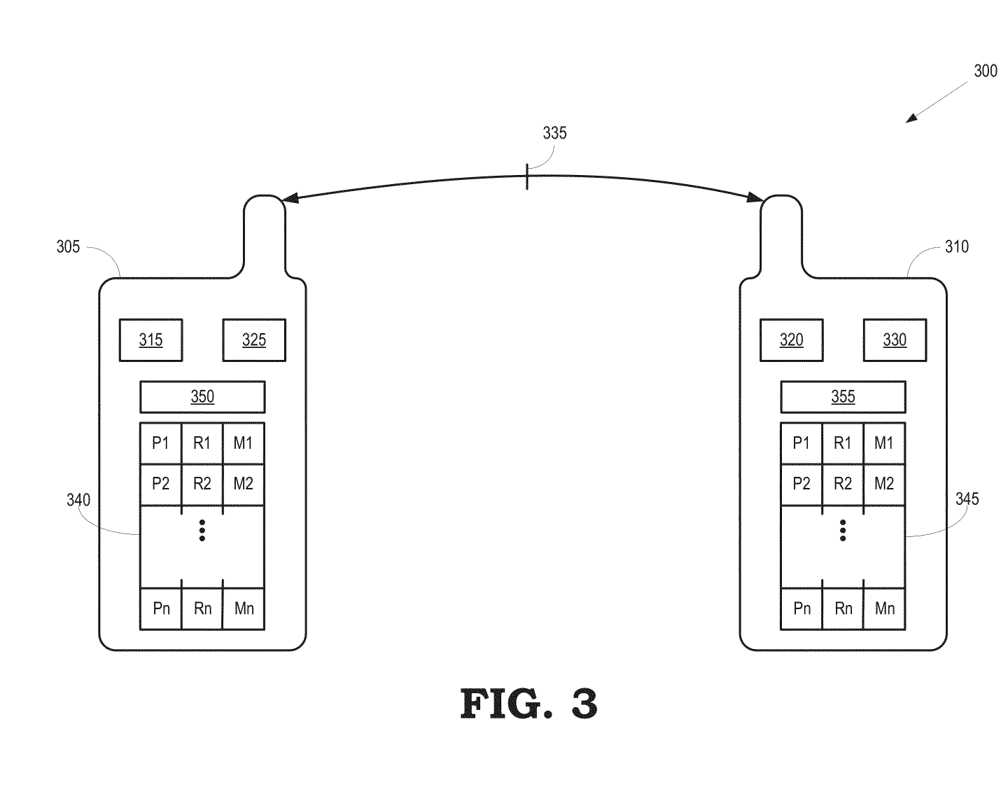

FIG. 3 is a block diagram of a wireless communication system 300 that supports D2D communication according to some embodiments. The wireless communication system 300 includes user equipment 305, 310, which may correspond to user equipment 110-112 shown in FIG. 1. Each user equipment 305, 310 includes transmitter 315, 320 and receiver 325, 330. Although the transmitter 315, 320 and the receiver 325, 330 are depicted as separate structures in FIG. 3, some embodiments of the user equipment 305, 310 may implement both the transmitter 315, 320 and the receiver 325, 330 into a single transceiver structure. The transmitter 315, 320 and the receiver 325, 330 can be used to transmit and receive signals over D2D communication channels of an air interface 335 that is formed directly between the user equipment 305, 310. No network elements are present in the communication path between the user equipment 305, 310 during D2D communication.

The user equipment 305, 310 include data structures 340, 345 that are used to store information that maps values of preambles (P1-Pn) or preamble resources (R1-Rn) to communication resource distributions (M1-Mn). The data structures 340, 345 may be formed using memory elements, registers, or other structures. Although the data structures 340, 345 indicate a mapping between the values of preambles (P1-Pn), the preamble resources (R1-Rn), and the communication resource distributions (M1-Mn), some embodiments may indicate mappings between different parameters. For example, if the same preamble resource is to be used for transmitting the preamble in all cases, the data structures 340, 345 may only indicate a mapping between the values of preambles (P1-Pn) and the communication resource distributions (M1-Mn). Information in the data structures 340, 345 may be pre-configured, e.g., by the D2D controller 130 shown in FIG. 1, to allow user equipment 305, 310 to establish D2D communication channels in an out-of-coverage or network-absent scenario. Information in the data structures 340, 345 may also be provided or modified dynamically using information provided by the D2D controller 130 while the user equipment 305, 310 are in coverage or in a network-assist mode.

The values of the preambles (P1-Pn) may indicate unique identifiers or sequences. For example, the values of the preambles (P1-Pn) may indicate different constant-amplitude-zero-autocorrelation (CAZAC) sequences such as Zadoff-Chu sequences. The different preambles may be assigned to different user equipment 305, 310 or different groups of user equipment and may be used to indicate different communication resource distributions. For example, one set of preambles or preamble resources may be allocated to user equipment used by the fire department and a different set may be allocated to user equipment used by the police department. The values of the preamble resources (R1-Rn) stored in the data structures 340, 345 may be used indicate the physical resource blocks that are used to transmit the preambles, e.g., one or more of the physical resource blocks 210 shown in FIG. 2. The values of the communication resource distributions (M1-Mn) stored in the data structures 340, 345 may be used to indicate the physical resource blocks that are used to support the D2D communication channel, e.g., subsets of the physical resource blocks 210 shown in FIG. 2.

The different communication resource distributions (M1-Mn) may correspond to larger or smaller numbers of communication resources such as physical resource blocks or they may correspond to different distributions of the physical resource blocks in the physical resource grid of a timeslot. The different communication resource distributions (M1-Mn) may also be associated with different types of communication (e.g., voice, data, or multimedia) or different data rates. For example, different communication resource distributions (M1-Mn) may include larger numbers of physical resource blocks to support higher data rates and lower numbers of physical resource blocks to support lower data rates.

In one embodiment, user equipment 305 may request reservation of resources of the air interface 335 for D2D communication with the user equipment 310 (and any other user equipment in the wireless communication system 300) by transmitting a preamble in a preamble resource that is shared with other user equipment 310. Some embodiments of the user equipment 305, 310 include D2D selection logic 350, 355 that can select a preamble or preamble resource that indicates one of the communication resource distributions that corresponds to the communication resources that the user equipment 305 is trying to reserve for D2D communication. For example, user equipment 305 may transmit the preamble P1 in the preamble resource R1 to request the communication resources indicated by the communication resource distribution M1 for D2D communication over one or more D2D communication channels. For another example, user equipment 305 may transmit the preamble Pn in the preamble resource Rn to request the communication resources indicated by the communication resource distribution Mn, which differs from the communication resources indicated by the communication resource distribution M1.

Transmission of the same preamble (e.g., P1) in different preamble resources (e.g., R1 or R2) may also be used to indicate different communication resource distributions. Transmission of different preambles (e.g., P1 and P2) in the preamble resource (e.g., R1) may be used to indicate different communication resource distributions. Some embodiments may allow user equipment 305 to make a standing reservation for the communication resources associated with a communication resource distribution. The standing reservation is then maintained (e.g., the communication resources are allocated to the user equipment 305 in successive timeslots or subframes) until the user equipment 305 transmits a stop preamble that indicates that the standing reservation has been terminated and thereby release the communication resources from the standing reservation. Some embodiments of the user equipment 305, 310 may also be able to request different communication resource distributions at different time intervals. For example, the communication resource distribution M1 may be requested every 10 ms whereas the communication resource distribution M2 may be requested every 5 ms. The request time intervals may be indicated in the data structures 340, 345.

After transmitting the preamble in the preamble resource, the user equipment 305 may transmit voice or data information over the D2D communication channel using the communication resources indicated by the preamble or preamble resource in response to an indication that the preamble did not collide with transmission from another user equipment (or absence of an indication that the preamble collided with transmission from another user equipment). User equipment 305, 310 may use one or more collision detection or avoidance techniques, or combinations thereof, to determine whether a collision occurred in the preamble resource. Some embodiments of the user equipment 305, 310 may estimate a probability that a collision occurred and may therefore decide whether or not to transmit the voice or data information over the D2D communication channel based on whether the estimated probability exceeds or falls below a threshold value.

User equipment 310 (and any other user equipment in the wireless communication system 300) may monitor one or more of the preamble resources (R1-Rn) and attempt to decode signals received in these resources. Collisions between preambles transmitted by different user equipment in a preamble resource may make it difficult or impossible for the user equipment 310 to decode or detect the preamble in the preamble resources. In that case, the user equipment 310 may not successfully decode or detect the preamble and consequently may not monitor any communication resources for D2D communication. If user equipment 310 is able to successfully decode and detect a preamble in one or more of the preamble resources (R1-Rn), the user equipment 310 may identify the communication resource distribution indicated by the preamble or the preamble resource using the mapping indicated in the data structure 345. The user equipment 310 may then monitor the communication resources indicated by the communication resource distribution for D2D communication. For example, the logic 355 may use the detected preamble and preamble resource to identify the communication resource distribution and then use this information to configure the receiver 330 to monitor the appropriate communication resources. In some embodiments, the detected preamble and preamble resource may indicate a standing reservation, in which case the user equipment 310 will continue to monitor the communication resources until the standing reservation has been terminated by reception of the terminating preamble.

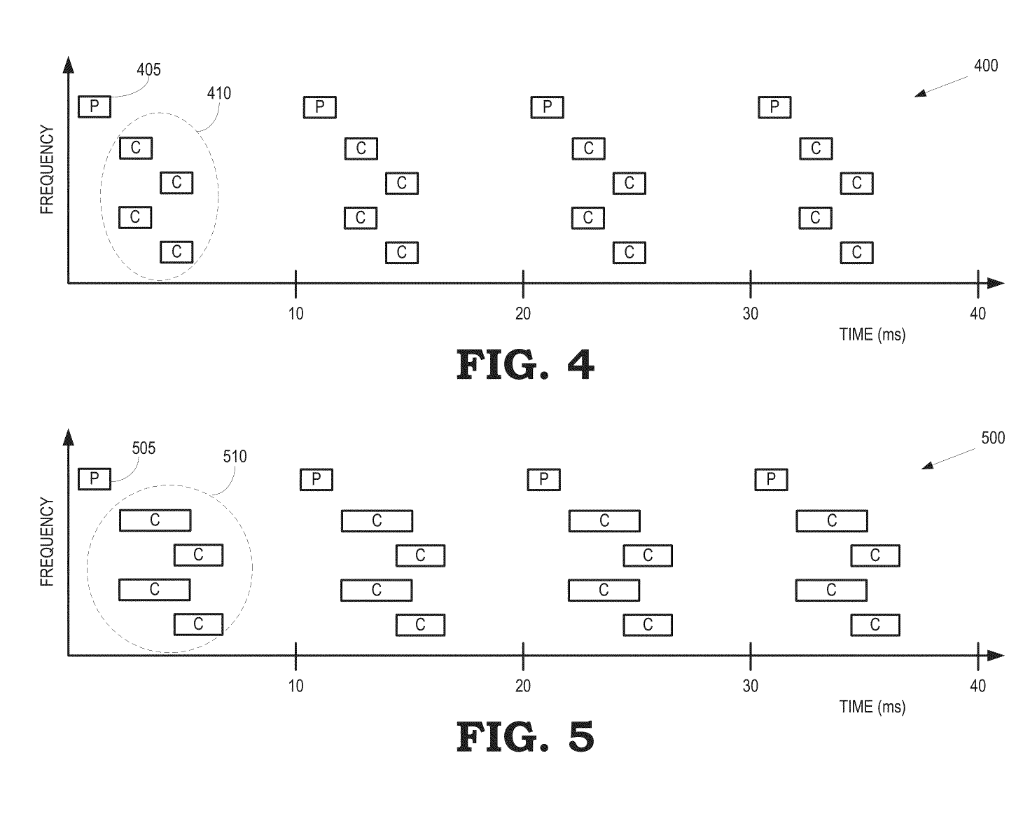

FIG. 4 is a plot 400 of preamble resources 405 that may be used to transmit a preamble (P) to indicate a communication resource distribution 410 according to some embodiments. The horizontal axis indicates time in milliseconds and the vertical axis indicates frequency in arbitrary units. Each box indicates one or more physical resource blocks allocated to the preamble resource 405 or a communication resource (C). User equipment may therefore transmit a preamble (P) once every 10 ms in the preamble resource 405 to indicate a request to reserve the communication resources (C) in the communication resource distribution 410 for establishing one or more D2D communication channels for D2D communication. As discussed herein, the mapping between the preamble (P) or the preamble resource 405 and the communication resource distribution 410 may be indicated by a mapping in a data structure such as the data structures 340, 345 shown in FIG. 3.

FIG. 5 is a plot 500 of preamble resources 505 that may be used to transmit a preamble (P) to indicate a communication resource distribution 510 according to some embodiments. The horizontal axis indicates time in milliseconds and the vertical axis indicates frequency in arbitrary units. Each box indicates one or more physical resource blocks allocated to the preamble resource 505 or a communication resource (C). User equipment may therefore transmit a preamble (P) once every 10 ms in the preamble resource 505 to indicate a request to reserve the communication resources (C) in the communication resource distribution 510 for establishing one or more D2D communication channels for D2D communication. The communication resource distribution 510 shown in FIG. 5 differs from the communication resource distribution 410 shown in FIG. 4 because the communication resource distribution 510 includes variable sized communication resource blocks (C). As discussed herein, the mapping between the preamble (P) or the preamble resource 505 and the communication resource distribution 510 may be indicated by a mapping in a data structure such as the data structures 340, 345 shown in FIG. 3.

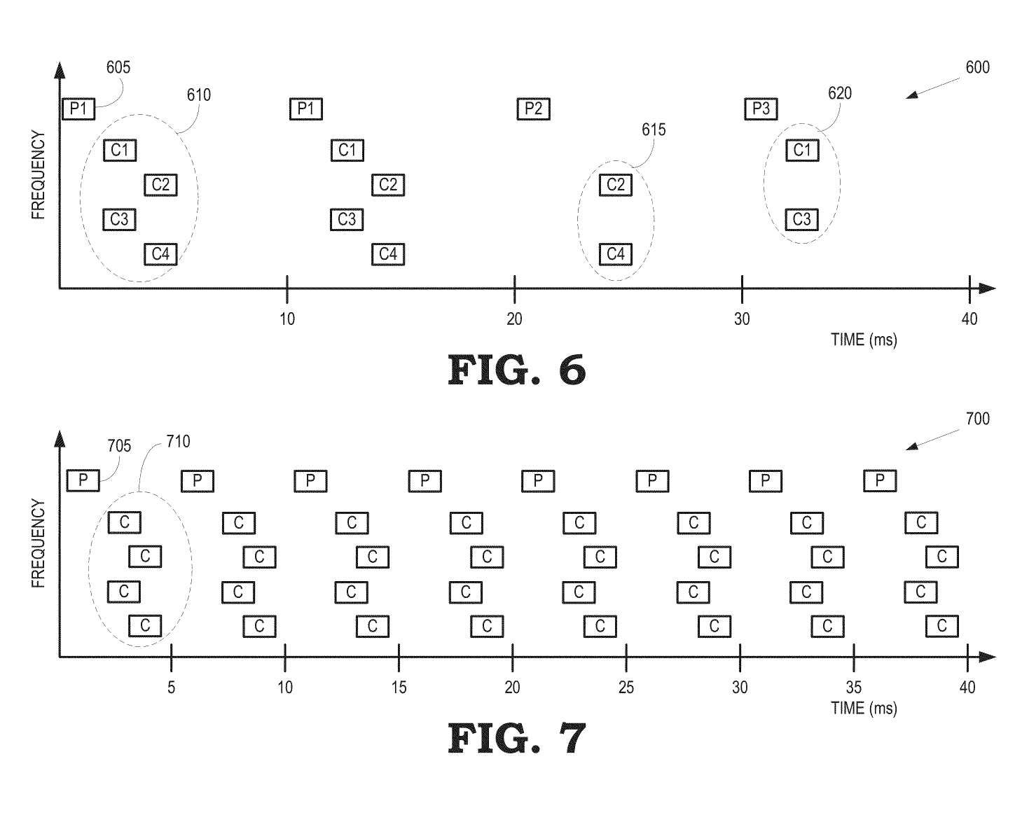

FIG. 6 is a plot 600 of preamble resources 605 that may be used to transmit one of a plurality of preambles (P1, P2, P3) to indicate one of a plurality of communication resource distributions 610, 615, 620 according to some embodiments. The horizontal axis indicates time in milliseconds and the vertical axis indicates frequency in arbitrary units. Each box indicates one or more physical resource blocks allocated to the preamble resource or a communication resource (C1, C2, C3, C4). User equipment may therefore transmit one of the plurality of preambles (P1, P2, P3) once every 10 ms in the preamble resource 605 to indicate a request to reserve one or more of the communication resources (C1, C2, C3, C4) in the communication resource distributions 610, 615, 620 for establishing one or more D2D communication channels for D2D communication. For example, user equipment may transmit the preamble (P1) in the preamble resource 605 to request reservation of the communication resources (C1, C2, C3, C4) in the communication distribution 610. For another example, user equipment may transmit the preamble (P2) in the preamble resource 605 to request reservation of the communication resources (C2, C4) in the communication distribution 615. For another example, user equipment may transmit the preamble (P3) in the preamble resource 605 to request reservation of the communication resources (C1, C3) in the communication distribution 620. The communication resources in the communication distributions 610, 615, 620 at least partially overlap. However, in some embodiments the communication resources indicated by the different preambles (P1, P2, P3) may not overlap. As discussed herein, the mapping between the plurality of preambles (P1, P2, P3) or the preamble resource 605 and the communication resource distributions 610, 615, 620 may be indicated by a mapping in a data structure such as the data structures 340, 345 shown in FIG. 3.

FIG. 7 is a plot 700 of preamble resources 705 that may be used to transmit a preamble (P) to indicate a communication resource distribution 710 according to some embodiments. The horizontal axis indicates time in milliseconds and the vertical axis indicates frequency in arbitrary units. Each box indicates one or more physical resource blocks allocated to the preamble resource 705 or a communication resource (C). The preamble resource 705 and the communication resource distributions 710 shown in FIG. 7 differ from the communication resource distribution 410 shown FIG. 4 because the two embodiments use different transmission time intervals. For example, user equipment may transmit a preamble (P) once every 5 ms in the preamble resource 705 to indicate a request to reserve the communication resources (C) in the communication resource distribution 710 for establishing one or more D2D communication channels for D2D communication. As discussed herein, the mapping between the preamble (P) or the preamble resource 705 and the communication resource distribution 710 may be indicated by a mapping in a data structure such as the data structures 340, 345 shown in FIG. 3.

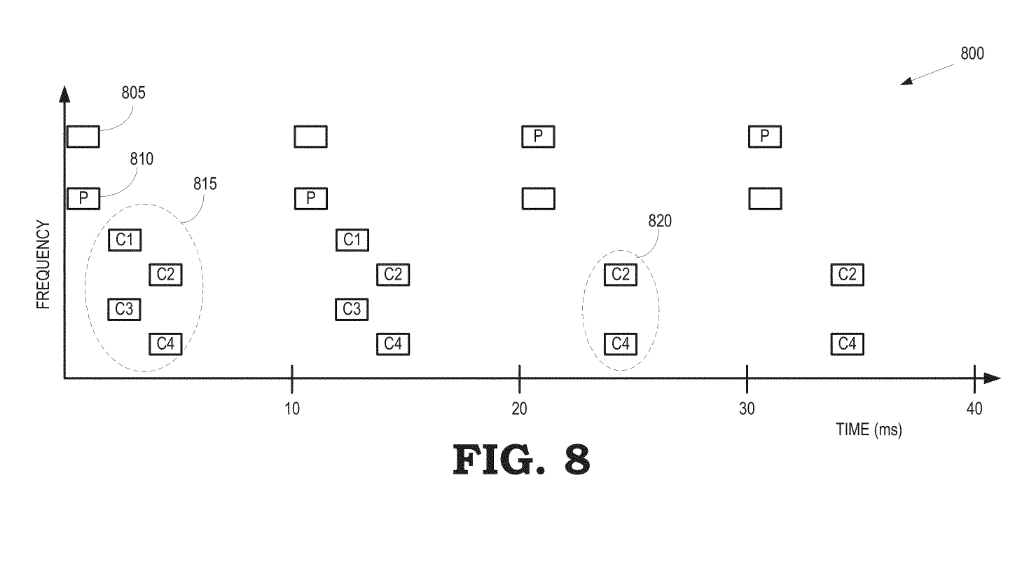

FIG. 8 is a plot 800 of preamble resources 805, 810 that may be used to transmit a preamble (P) to indicate one of a plurality of communication resource distributions 815, 820 according to some embodiments. The horizontal axis indicates time in milliseconds and the vertical axis indicates frequency in arbitrary units. Each box indicates one or more physical resource blocks allocated to the preamble resources 805, 810 or a communication resource (C1, C2, C3, C4). User equipment may therefore transmit the preamble once every 10 ms in one or more of the preamble resources 805, 810 to indicate a request to reserve one or more of the communication resources (C1, C2, C3, C4) in the communication resource distributions 815, 820 for establishing one or more D2D communication channels for D2D communication. For example, user equipment may transmit the preamble (P) in the preamble resource 810 to request reservation of the communication resources (C1, C2, C3, C4) in the communication distribution 815. For another example, user equipment may transmit the preamble (P) in the preamble resource 805 to request reservation of the communication resources (C2, C4) in the communication distribution 820. The communication resources in the communication distributions 815, 820 at least partially overlap. However, in some embodiments the communication resources indicated by the different preamble resources 805, 810 may not overlap. As discussed herein, the mapping between the preamble (P) or the preamble resources 805, 810 and the communication resource distributions 815, 820 may be indicated by a mapping in a data structure such as the data structures 340, 345 shown in FIG. 3.

Some embodiments of wireless communication systems may implement or support D2D communication between user equipment using some or all of the techniques discussed herein with regard to FIGS. 4-8. Furthermore, some embodiments may use different combinations of the techniques discussed herein with regard to FIGS. 4-8 to support flexible configuration of the D2D communication channels between user equipment. Some embodiments described herein may be combined to support requests for low data rate communication and high data rate communication. For example, the technique described herein with regard to FIG. 4, which uses a time interval of 10 ms between sets of preamble resources and communication resources, may be used to support relatively low data rate communication. This technique may be combined with the technique described herein with regard to FIG. 7, which uses a shorter time interval of 5 ms between sets of preamble resources and communication resources to support relatively high data rate communication. Some embodiments may also assign different preambles or different preamble resources to different groups of user equipment so that user equipment in the different groups only monitor their assigned set of preambles or preamble resources.

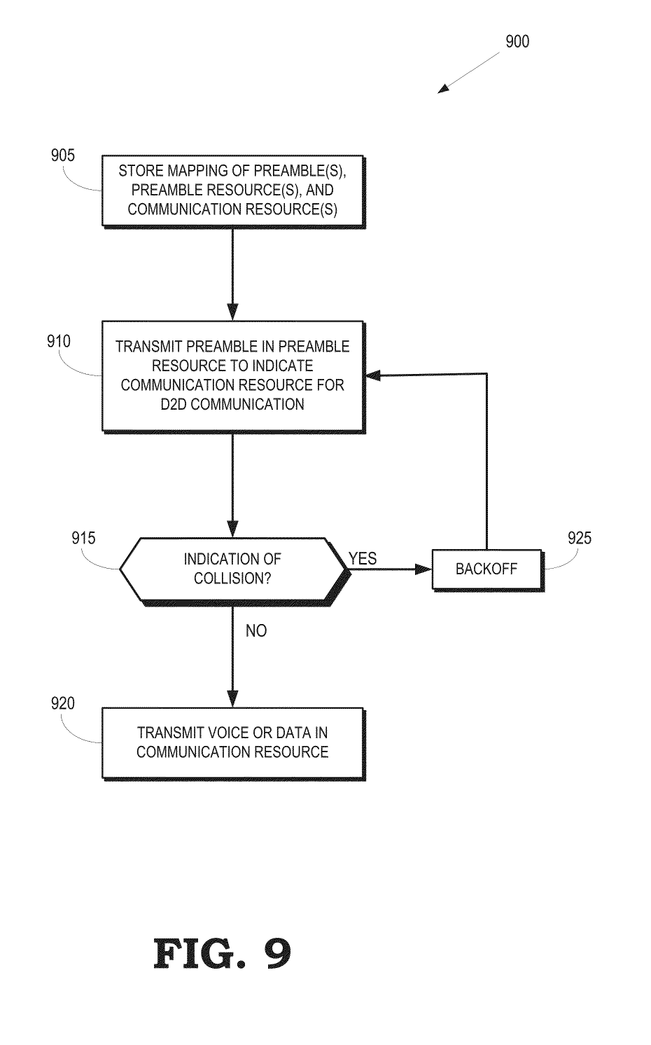

FIG. 9 is a flow diagram of a method 900 for requesting resources for D2D communication according to some embodiments. At block 905, user equipment store a mapping of one or more preambles, one or more preamble resources, and one or more communication resources. For example, user equipment may store the mapping in a data structure such as the data structures 340, 345 shown in FIG. 3. At block 910, the user equipment transmits a preamble in a preamble resource to indicate one or more communication resources that are being requested for D2D communication. At decision block 915, the user equipment determines whether there is an indication of a collision in the preamble resource. If not, the user equipment may assume that no other user equipment are attempting to reserve the communication resources by transmitting a preamble in the preamble resource. The user equipment may therefore transmit voice or data in the communication resources at block 920. If there is an indication of a collision in the preamble resource, the user equipment may assume that one or more other user equipment are attempting to reserve the same communication resources. The user equipment may therefore back off by a predetermined or random time interval at block 925. The user equipment may subsequently re-transmit the preamble in the preamble resource to request access to the communication resource at block 910.

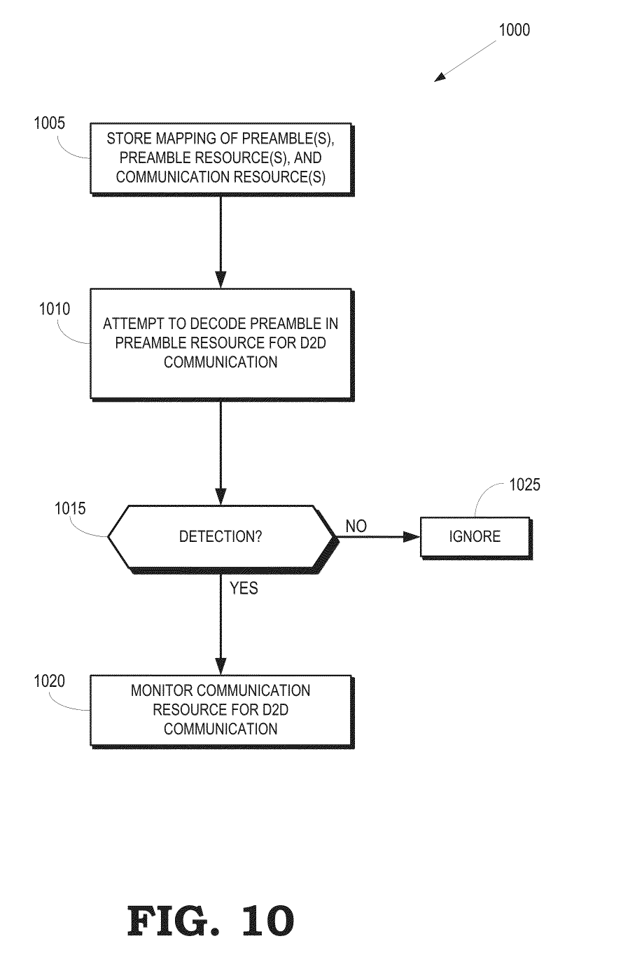

FIG. 10 is a flow diagram of a method 1000 for receiving D2D communication using requested communication resources according to some embodiments. At block 1005 user equipment may store a mapping of one or more preambles, preamble resources and communication resources. For example, user equipment may store the mapping in a data structure such as the data structures 340, 345 shown in FIG. 3. At block 1010, user equipment attempt to decode a preamble in a preamble resource that is used to request reservation of communication resources for D2D communication. If user equipment successfully detects and decodes the preamble in the preamble resource (at decision block 1015), the user equipment can monitor the communication resources indicated by the preamble for the preamble resource for D2D communication from the user equipment that transmitted the preamble in the preamble resource. If the user equipment does not successfully detect or decode the preamble in the preamble resource (at decision block 1015), the user equipment may ignore the request and may not monitor any communication resources for D2D communication.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)). The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
transmitting a preamble in a preamble resource to indicate at least one communication resource for a device-to-device (D2D) communication channel; and
transmitting voice or data over the D2D communication channel using the at least one communication resource in response to absence of an indication of a collision in the preamble resource.

2. The method of claim 1, further comprising:
selecting the preamble from a plurality of preambles associated with a plurality of communication resource distributions based on a mapping between the plurality of communication resource distributions and at least one of the plurality of preambles and a plurality of preamble resources.

3. The method of claim 2, wherein selecting the preamble comprises selecting one of the plurality of preambles that maps to one of the plurality of communication resource distributions that indicates the at least one communication resource for the D2D communication channel.

4. The method of claim 2, wherein the plurality of communication resource distributions indicate different amounts of communication resources for the D2D communication channel.

5. The method of claim 2, further comprising:
selecting the preamble resource from the plurality of preamble resources based on the mapping between the plurality of communication resource distributions and at least one of the plurality of preambles and the plurality of preamble resources.

6. The method of claim 5, wherein the plurality of preamble resources are allocated at different transmission time intervals.

7. The method of claim 2, further comprising:
storing information indicating the mapping between the plurality of communication resource distributions and at least one of the plurality of preambles and the plurality of preamble resources.

8. The method of claim 1, wherein the preamble indicates a standing reservation for the at least one communication resource, and further comprising:
transmitting a stop preamble to release the at least one communication resource from the standing reservation.

9. A method comprising:
detecting a preamble in a preamble resource that indicates at least one communication resource for a device-to-device (D2D) communication channel; and
monitoring the at least one communication resource for D2D communication in response to detecting the preamble in the preamble resource.

10. The method of claim 9, wherein monitoring the at least one communication resource comprises monitoring at least one communication resource indicated by one of a plurality of communication resource distributions and a mapping between the plurality of communication resource distributions and at least one of a plurality of preambles and a plurality of preamble resources.

11. The method of claim 10, wherein the plurality of communication resource distributions indicate different amounts of communication resources for the D2D communication channel.

12. The method of claim 10, wherein detecting the preamble in the preamble resource comprises detecting the preamble in one of the plurality of preamble resources that is indicated by the mapping between the plurality of communication resource distributions and at least one of the plurality of preambles and the plurality of preamble resources.

13. The method of claim 12, wherein the plurality of preamble resources are allocated at different transmission time intervals.

14. The method of claim 10, further comprising:
storing information indicating the mapping between the plurality of communication resource distributions and at least one of the plurality of preambles and the plurality of preamble resources.

15. The method of claim 10, wherein monitoring the at least one communication resource comprises monitoring the at least one communication resource and subsequent transmission time intervals until receiving a stop preamble to release the at least one communication resource.

16. An apparatus comprising:
a transmitter to transmit a preamble in a preamble resource to indicate at least one communication resource for a device-to-device (D2D) communication channel and transmit voice or data over the D2D communication channel using the at least one communication resource in response to absence of an indication of a collision in the preamble resource.

17. The apparatus of claim 16, further comprising:
a receiver to detect a preamble in a preamble resource that indicates at least one communication resource for a device-to-device (D2D) communication channel and monitor the at least one communication resource for D2D communication in response to detecting the preamble in the preamble resource.

18. The apparatus of claim 16, further comprising:
a storage elements to store information indicating a mapping between a plurality of communication resource distributions and at least one of a plurality of preambles and a plurality of preamble resources.

19. The apparatus of claim 18, further comprising:
logic to select the preamble from a plurality of preambles associated with a plurality of communication resource distributions based on a mapping between the plurality of communication resource distributions and at least one of the plurality of preambles and a plurality of preamble resources.

20. The apparatus of claim 18, further comprising:
logic to select the preamble resource from the plurality of preamble resources based on the mapping between the plurality of communication resource distributions and at least one of the plurality of preambles and the plurality of preamble resources.
